(19) United States
(12) Patent Application Publication
(10) Pub. No.: US 2010/0141811 A1
(43) Pub. Date: Jun. 10, 2010

(54) COLOR TEMPERATURE COMPENSATING IMAGING APPARATUS AND METHOD

(75) Inventor: Yoshiharu Gotanda, Yokohama (JP)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: Samsung Techwin Co., Ltd., Changwon-city (KR)

(21) Appl. No.: 12/350,353

(22) Filed: Jan. 8, 2009

(30) Foreign Application Priority Data
Dec. 10, 2008 (KR) 10-2008-0125344

(51) Int. Cl. H04N 9/64

(52) U.S. Cl. 348/256; 348/E09.037

(57) ABSTRACT

Provided are a color temperature compensating imaging apparatus and an method, which are used to acquire good image quality under mixed light (MIX light) conditions. The apparatus includes a gain acquisition unit for acquiring gains of color signals to control a white balance of an image of a subject; an illumination unit including a light source of which illumination color temperature is controlled when the subject is illuminated; and an illumination control unit that calculates the illumination color temperature based on the acquired gains, and adjusts the illumination device color temperature.

### CROSS-REFERENCE TO RELATED PATENT APPLICATION

This application claims the benefit of Korean Patent Application No. 10-2008-0125344, filed on Dec. 10, 2008, in the Korean Intellectual Property Office, the disclosure of which is incorporated herein in its entirety by reference.

### BACKGROUND OF THE INVENTION

1. Field of the Invention

The present invention relates to an imaging apparatus and an imaging method. More specifically, the invention relates to a method and system for measuring and compensating for color temperature.

2. Description of the Related Art

Along with an imaging apparatus, such as a digital camera, photographers often use an illumination device, such as a flash. While shooting photographs, a white balance setting for the illumination device can be manually adjusted to match the white color in an image captured by the imaging apparatus to the same white color of a subject. By convention, the spectrum of colors produced by an illumination device is measured in units of temperature because the spectrum of colors produced by thermal radiation from a blackbody, such as a filament, changes with temperature. Higher color temperature corresponds to a broader color spectrum encompassing a wider range of reds, greens, and blues. In accordance with industry standards, the color temperature of a flash is often fixed to 6500 K. Accordingly, when the white balance is adjusted during flash photography, the imaging apparatus controls gains of respective color signals of red (R), green (G), and blue (B) based on the color temperature of the illumination device (typically, 6500 K).

Conventional techniques for imaging and illumination encounter problems, however, when light is provided from sources besides an illumination device. For example, when a subject standing in front of an indoor wall is illuminated by both an incandescent lamp (such as a tungsten lamp) and a flash, a mixed light (MIX light) is formed because the color temperature of the light source is different from the color temperature of the illuminating device shedding light onto the indoor wall. Typically, the image of the subject will appear cooler and the background warmer than they appear to the naked eye. Conventional techniques make good white balance difficult to obtain.

There are other techniques used for achieving white balance. A first relies upon an optical filter installed in front of a light source of an illuminating device. This technique requires photographers to anticipate color problems by carrying the necessary filter. A second technique relies upon a strobe device including light emitting devices for each of the three primary colors (red, green, and blue), wherein the ratio of light emitted from each color of the light emitting devices is adjusted so that the strobe light approximates a desired color temperature. In accordance with the first and second techniques, color temperature of a subject is measured and then an illumination device having a color temperature that is equal to the measured color temperature of the subject is provided to photograph the subject. Formation of mixed light (MIX light) is thereby hindered. In a third technique, to prevent formation of a mixed light (MIX light), a user can manually adjust the imaging apparatus to the white balance of the surrounding environment. Often, in the third technique the flash or other illumination device is disabled.

A fundamental problem with preventing mixed light (MIX light) formation is that color temperature of the subject is difficult to measure. Difficulties may arise for a variety of reasons. For example, the color of the subject may not be separable from the color of the light source, the color of the subject may be similar to the color of an indoor light source, or the color of a light source alone can be difficult to measure.

Typically, the color temperature of the subject is not automatically measured for a white balance control of a digital camera. That is, a digital camera user typically determines manually an indoor light source and sets the color of the light source using a manual white balance mode (MWB).

Manual white balance adjustment is incompatible with the first and second techniques described above. Even when the first and second techniques are followed, when flash photography is performed the color temperature of the flash is determined based on the color temperature of the subject which has been measured without considering the color of the light source which is chosen by a user in the MWB. As a result, even when the color of the light source is chosen by the user, since the measured color temperature of the subject is not equal to the color temperature of the indoor light source, a mixed light (MIX light) may be formed.

Manual white balance adjustment is also incompatible with the third technique described above. In a manual mode in which a user sets a white balance, formation of the mixed light (MIX light) is prevented by hindering the illuminating device from emitting light. However, if photographing is performed without illumination, a shutter needs to be opened for a longer period of time, or a high gain is needed. As a result, image quality suffers.

### SUMMARY OF THE INVENTION

The present invention provides a color temperature compensating imaging apparatus and method, which are used to acquire an image of good quality and hinder formation of mixed light.

According to an aspect of the present invention, there is provided a color temperature compensating imaging apparatus, including a gain acquisition unit, an illumination unit, and an illumination control unit. The gain acquisition unit measures the gain of a color signal from a white balance of an image of a subject. The illumination unit comprises a light source with adjustable illumination color temperature. The illumination control unit calculates the illumination color temperature based on the gain measurement supplied by the gain acquisition unit and adjusts the illumination unit to achieve a calculated illumination color temperature.

The apparatus of the present invention may further include: a light receiving unit that receives light reflected or irradiated from the subject and separates the light into color signals of the three primary colors, and a memory for storing gains of the color signals corresponding to a plurality of patterns.

The gain acquisition unit calculates a relative intensity ratio of the color signals of the three primary colors. In an embodiment, the gain acquisition unit includes: a first mode for acquiring the gains based on the relative intensity ratio and a second mode for acquiring the gains according to any one pattern from the plurality of patterns. The illumination control unit calculates the illumination color temperature based on the gains acquired in any one mode of the first mode and the second mode.

The apparatus of the present invention may include a light receiving unit that receives light reflected or irradiated from the subject and separates the light into color signals of the three primary colors. In this embodiment, the gain acquisition unit calculates the relative intensity ratio of the color signals of the three primary colors and acquires the gains based on the relative intensity ratio.

In some embodiments, the present invention may include a memory storing gains of the at least two color signals corresponding to each of the plurality of patterns, wherein the gain acquisition unit acquires the gains according to any one pattern from the plurality of patterns.

In other embodiments, the present invention may include a white balance control unit that adjusts the color signal of the image of the subject based on the acquired gains and controls the white balance of the image of the subject.

According to another aspect of the present invention, there is provided a method for color temperature compensation. The method of the present invention includes steps of acquiring gains of color signals to control a white balance of an image of a subject; calculating an illumination color temperature of an illumination unit comprising a light source of which illumination color temperature is controlled when the subject is illuminated, based on the acquired gain; and controlling a control of the illumination color temperature in the illumination unit, based on the calculated illumination color temperature.

The imaging method may further include: receiving light from the subject and separating the light into color signals of the three primary colors; and memorizing gains of the color signals corresponding to a plurality of patterns in advance; wherein, for the calculating of the illumination color temperature, the illumination color temperature is determined based on the gains acquired in any one mode of the first mode and the second mode, wherein in the first mode, an intensity ratio of the color signals of the three primary colors is calculated and the gains are acquired based on the intensity ratio, in the second mode, the gains are acquired according to any one pattern from the plurality of patterns.

### BRIEF DESCRIPTION OF THE DRAWINGS

The above and other features and advantages of the present invention will become more apparent from a description in detail of exemplary embodiments thereof with reference to the attached drawings in which:

FIG. 1 is a block diagram illustrating an imaging apparatus according to an embodiment of the present invention;

FIG. 2 is a schematic view of an imaging area of a charge coupled device (CCD) according to an embodiment of the present invention;

FIG. 3 is a graph of a gain ratio of gains acquired by a white balance controller with respect to an illumination color temperature;

FIG. 4 is a circuit diagram illustrating illumination controllers and illuminating devices, according to an embodiment of the present invention;

FIG. 5 is a graph of a value of a light amount control signal transferred by D/A converters with respect to an illumination color temperature;

FIG. 6 is a conceptual diagram of a multiplication unit that multiplies color signals of R, G, and B colors by a gain;

FIG. 7 is a flowchart illustrating a white balance process of the imaging apparatus of FIG. 1;

FIG. 8 is a flowchart of a luminescence control process performed in the imaging apparatus of FIG. 1 in an auto white balance mode; and

FIG. 9 is a flowchart illustrating calculating the entire screen average value Rd of an R signal.

### DETAILED DESCRIPTION OF THE INVENTION

The present invention will now be described more fully with reference to the accompanying drawings, in which exemplary embodiments of the invention are shown. In the specification and the drawings, like reference numerals denote like elements, and thus their description will be omitted.

### Structure of the Apparatus

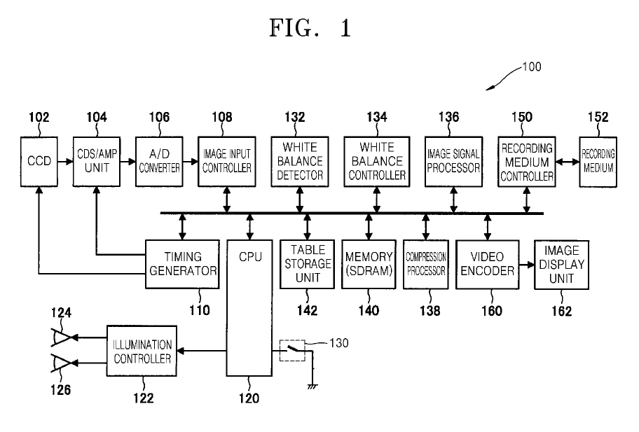

First, an apparatus 100 according to an embodiment of the present invention is described in detail. FIG. 1 is a block diagram illustrating the imaging apparatus 100.

Referring to FIG. 1, the imaging apparatus 100 according to the embodiment includes a charge coupled device (CCD) 102, a correlated double sampling/amplifier (CDS/AMP) unit 104, an A/D converter 106, an image input controller 108, a timing generator 110, a central processing unit (CPU) 120, an illumination controller 122, illuminating devices 124 and 126, a shutter switch or button 130, a white balance detector 132, a white balance controller 134, an image signal processor 136, a compression processor 138, a memory 140 (such as SDRAM), a table storage unit 142, a recording medium controller 150, a recording medium 152, a video encoder 160, and an image display unit 162.

The CCD 102 includes photoelectric converters that convert optical information that is incident to the device through an optical system into electrical signals, and each of the photoelectric converters generates an electric signal according to a received light. The CCD 102 is an example of an imaging device in the embodiment shown. However, the present invention is not limited thereto. For example, a complementary metal oxide semiconductor (CMOS) can also be used as an imaging device.

In addition, to control an exposure time of the CCD 102, a mechanical shutter (not shown) may be used in such a manner that when photographing is not performed, the CCD 102 is not exposed to light, and only when photographing is performed is the CCD 102 exposed to light. In addition, the exposure time can be controlled by using an electronic shutter (not shown). The operation of the mechanical shutter or the electronic shutter may be performed by using a switch of the shutter button 130 connected to the CPU 120.

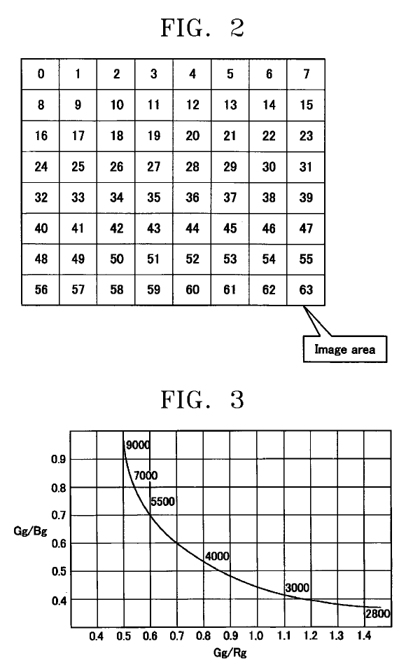

The CCD 102 has an imaging area illustrated in FIG. 2. In the embodiment shown, the imaging area is divided into 64 areas, area₀ through area₆₃. FIG. 2 is a schematic view of then imaging area of the CCD 102 according to the current embodiment. In other embodiments, the imaging area may be divided into a larger or smaller number of areas.

A step by step explanation of how the apparatus and method work in compensating for color temperature is now provided. After an image is captured by the CCD 102, the image is supplied to the CDS/AMP unit 104, which removes low-frequency noises included in the electrical signals transferred from the CCD 102, and amplifies the electrical signals to a predetermined level.

Analog to digital conversion follows. The A/D converter 106 then converts electrical signals transferred from the CDS/AMP unit 104 into digital signals. The A/D converter 106 also transfers the generated digital signals to the image input controller 108.

Following analog to digital conversion, a digital signal is supplied to the image input controller 108, which selectively supplies a signal to other image block units in the apparatus. The image input controller 108 processes the digital signals transferred from the A/D converter 106 and generates image signals that are used in an imaging process. The image input controller 108 transfers the generated image signals to, for example, a white balance detector 132 or an image signal processor 136.

The timing generator 110 inputs timing signals to the CCD 102 or the CDS/AMP unit 104 so as to control an exposure period or charge-reading of respective pixels that constitute the CCD 102.

In an embodiment, the CPU 120 functions as a computer processor and a controller that operates according to a program, and controls processing of many elements of the imaging apparatus 100, including elements not shown in FIG. 1. For example, in an embodiment the CPU 120 transfers a signal to a driver based on a focus control or an exposure control and drives the optical system for forming images. Also, the CPU 120 controls respective image forming elements of the imaging apparatus 100 based on signals transferred from a controller. In addition, although the embodiment shown uses only one CPU 120, a plurality of CPUs can be used to separately perform a command of a signal system and a command of a control system.

The illumination controller 122 calculates an illumination color temperature based on a gain acquired by the white balance controller 134, and controls illumination color temperatures of the illuminating devices 124 and 126 based on the calculated illumination color temperature. The gain acquired by the white balance controller 134 may vary according to an auto white balance mode and a manual white balance mode.

In an embodiment, the illumination controller 122 reads a relationship graph of a gain ratio with respect to an illumination color temperature illustrated in FIG. 3. Such a relationship graph can be stored in memory 140, or in a separate memory (not shown). The illumination controller 122 calculates gain ratios Gg/Bg and Gg/Rg based on gains acquired by the white balance controller 134, and an illumination color temperature of light emitted from the illuminating devices 124 and 126 based on the relationship graph of gain ratios Gg/Bg and Gg/Rg with respect to the illumination color temperature.

The illuminating devices 124 and 126 are an example of an illumination unit, and have two different color light sources so that the illumination color temperature can be controlled when a subject is illuminated. The illuminating devices 124 and 126 may include, for example, a light emitting diode (LED). The illumination unit includes, for example, a low color temperature LED 124 and a high color temperature LED 126. The current embodiment uses the illumination unit including two different color light sources, but the present invention is not limited thereto. For example, the illumination unit may include one light source, or three or more different light sources.

The illumination controller 122 and the illuminating devices 124 and 126 may form a circuit like the one shown by way of example in FIG. 4. The circuit diagram shown in FIG. 4 is a circuit diagram of the illumination controller 122 and the illuminating devices124 and 126, according to one embodiment of the present invention. The illumination controller 122 may include, for example, D/A converters 202 and 203 and current limitation circuits 212 and 222.

A power source unit 201 supplies electric power to the low color temperature LED 124 and the high color temperature LED 126. The low color temperature LED 124 is connected to the current limitation circuit 212, and the high color temperature LED 126 is connected to the current limitation circuit 222. The current limitation circuit 212 is connected to the D/A converter 202, and the current limitation circuit 212 receives an illumination amount control signal for a low color temperature transferred by the D/A converter 202. The current limitation circuit 222 is connected to the D/A converter 203, and the current limitation circuit 222 receives an illumination amount control signal for a high color temperature transferred by the D/A converter 203. The current limitation circuits 212 and 222 are connected to a ground terminal 204.

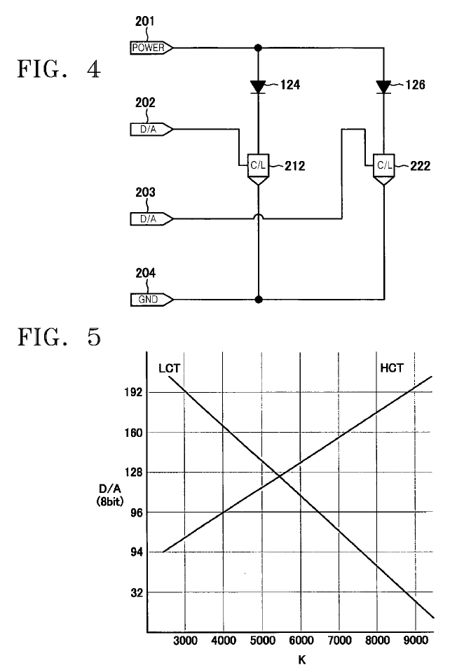

The illumination controller 122 may read a graph illustrated in FIG. 5, which may be stored in memory 140, or in a separate memory. FIG. 5 is a graph of a value of an illumination control signal transferred by the D/A converters 202 and 203 with respect to an illumination color temperature. For example, the illumination controller 122 calculates signal values transferred to the illuminating devices 124 and 126 based on the illumination color temperature that has been calculated using gains illustrated in FIG. 5. If the illumination color temperature is higher, the illumination controller 122 transfers a lower signal value to the low color temperature LED 124 and a higher signal value to the high color temperature LED 126.

In an auto white balance mode, the white balance detector 132 calculates a relative intensity ratio of color signals of the three primary colors with respect to a subject photographed, so that the white balance controller 134 acquires gains of the color signals. To calculate the relative intensity ratio of color signals of the three primary colors, the white balance detector 132 adds up signal levels (intensities of color signal) of a pixel with respect to color signals of the three primary colors (Rsignal, Gsignal, and Bsignal) and calculates an average value of signal intensities per pixel.

In the auto white balance mode, the white balance controller 134 calculates a gain of a color signal for a white balance control based on the relative intensity ratio of color signals of the three primary colors calculated by the white balance detector 132 and acquires the gain.

In a manual white balance mode, the white balance controller 134 acquires any one light source pattern selected from a plurality of light source patterns stored in the table storage unit 142, which is chosen by a user, and acquires gains of color signals of the three primary colors corresponding to the light source pattern. The white balance controller 134 is an example of a gain acquisition unit.

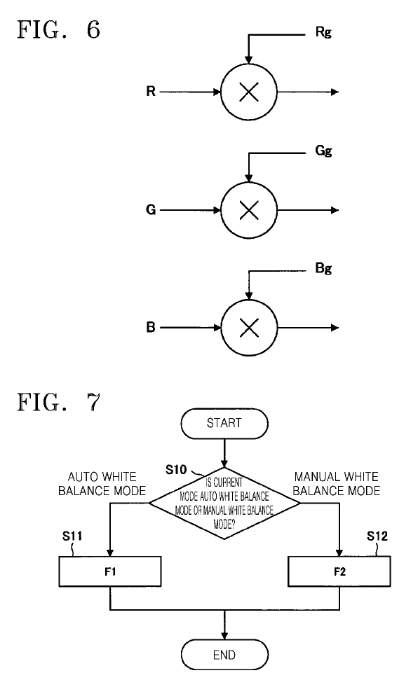

Also, the white balance controller 134, as illustrated in FIG. 6, multiplies a gain of a color signal of each color by a color signal value and outputs a white balance controlled signal. FIG. 6 is a conceptual diagram of a multiplication unit that multiplies a color signal value by a gain of a color signal of respective RGB colors.

The image signal processor 136 forms an image and transfers the formed image to the memory 140. The compression processor 138 converts input image data that are formed of digital signals into compressed data, such as JPEG compression type data or LZW compression type data.

The memory 140 may be, for example, a semiconductor memory device, such as synchronous DRAM (SDRAM). The memory 140 may temporarily store time division captured image. Also, the memory 140 stores an operation program of the CPU 120.

The table storage unit 142 stores a light source pattern that is chosen by a user in the manual white balance mode. There are a plurality of light source patterns as described in Table 1 below, and with respect to each of the patterns, gains of color signals of the three primary colors are memorized. The light source pattern may be, for example, a DayLight mode, a Shadow mode, a Cloudy mode, a Tungsten mode, or a Fluorescent mode. Table 1 shows gains of color signals of the three primary colors Rg, Gg, and Bg, with respect to respective light source patterns. However, the present invention is not limited to the light source patterns or gains. That is, other light source patterns or other gains can also be used in the present invention.

TABLE 1

| Selected light | WB-Gain | | |
|---|---|---|---|
| source (S) | Rg | Gg | Bg |
| 0 (Day Light) | 2.0 | 1.2 | 1.8 |
| 1 (Shadow) | 2.4 | 1.2 | 1.3 |
| 2 (Cloudy) | 2.2 | 1.2 | 1.0 |

The recording medium controller 150 controls writing of image data in the recording medium 152, or reading of image data or setting information recorded in the recording medium 152. The recording medium 152 may be, for example, an optical recording medium (CD or DVD), a magneto-optical disc, a magnetic disc, or a semiconductor memory medium. The recording medium 152 records captured image data. The recording medium controller 150 and the recording medium 152 may be separable from the imaging apparatus 100. The video encoder 160 compresses moving images and transfers the compressed frames to the image display unit 162.

The image display unit 162 is driven and controlled by a display control unit. The image display unit 162 may be, for example, a display member, such as a liquid crystal display. The image display unit 162 displays a live view read from VRAM before an image is manipulated, various setting screens of the imaging apparatus 100, or an image recorded by imaging. VRAM is a memory for displaying images, and includes a plurality of channels so that writing of a display image and displaying on the image display unit 162 can be performed at the same time.

The imaging apparatus 100 according to the current invention includes an optical system for forming images in front of the CCD 102. The optical system for forming images is an optical system that images external optical information in the CCD 102. The optical system for forming images may includes a lens unit (not shown), a zoom member (not shown), a focus member (not shown) including a focusing lens, an iris member (not shown) that changes the size of an opening and defines the direction or range of luminous flux, and a body tube (not shown) to which a lens is attached. The optical system for forming images may be, for example, a single-focus lens or a zoom lens. A motor driver may drive, for example, the zoom member, focus member, and iris member of the optical system for forming images.

### The Operation of the Present Invention

The method whereby of the color temperature compensating imaging apparatus 100 operates will now be described in detail. FIG. 7 is a flowchart illustrating a white balance process of the imaging apparatus 100.

First, the imaging apparatus 100 determines that a white balance mode of a white balance controller is an auto white balance mode or a manual white balance mode (S10). If the white balance mode is the auto white balance mode, S11 is performed and the corresponding luminescence control process, which will be described later, is performed. On the other hand, if the white balance mode is the manual white balance mode, S12 is performed and the corresponding luminescence control process, which will be described later, is performed.

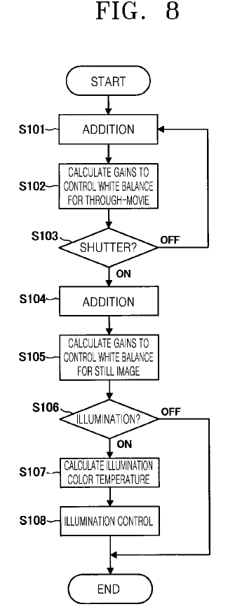

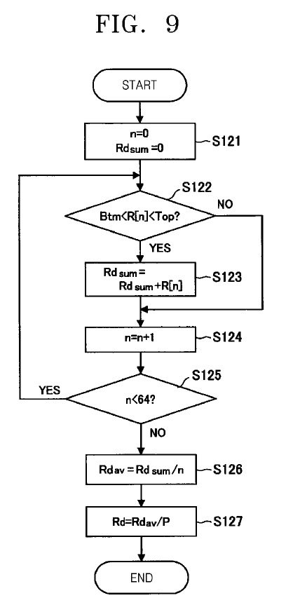

The luminescence control process of the auto white balance mode will now be described in detail by reference to FIG. 8. FIG. 8 is a flowchart illustrating the luminescence control process that is executed when the color temperature compensating imaging apparatus 100 is in an auto white balance mode.

Before the process shown in FIG. 8 begins, the imaging apparatus 100 has performed a white balance measurement through the lens (i.e., with a live-view). The imaging apparatus 100 has received light, acquired image signals in the CCD 102, and performed a white balance control based on color signals of the three primary colors among the image signals.

In the first step (S101) of FIG. 8, the white balance detector 132 calculates a relative ratio of color signal intensities of the three primary colors, and based on such intensity ratios, gains of the color signals are acquired to perform the white balance control. To calculate the relative ratio of the color signal intensities of the three primary colors, the white balance detector 132 adds up signal levels (intensities of color signal) of color signals Rsignal, Gsignal, and Bsignal of the three primary colors in respective division areas of the imaging area of the CCD 102 (S101).

For example, with respect to a pixel, the signal level of a Rsignal is denoted by Rpixel, the signal level of a Gsignal is denoted by Gpixel, the signal level of a Bsignal is denoted by Bpixel, and the sums of respective signal levels Rsignal, Gsignal, and Bsignal in a division area areaₙ may be represented by, for example, the following equation:

$${R}_{n} = {\sum }_{{area}_{n} start}^{{area}_{n} end} Rpixel , \\ {G}_{n} = {\sum }_{{area}_{n} start}^{{area}_{n} end} Gpixel , \\ {B}_{n} = {\sum }_{{area}_{n} start}^{{area}_{n} end} Bpixel \qquad Equation 1$$

If the imaging area is divided into 64 areas as illustrated in FIG. 2 and the division areas include area₀ through area₆₃, the sums of respective signal levels Rsignal, Gsignal, and Bsignal in each pixel in the division areas area₀ through area₆₃, such as R₀, G₀, B₀, R₁, G₁, B₁ through R₆₃, G₆₃, or B₆₃ are calculated.

Referring again to FIG. 8, next the white balance controller 134 calculates a gain of a color signal to control a white balance (S102). The gain calculation process will be described in detail later.

The through-the-lens white balance measurement is continuously recalculated based on the gain until the shutter button 130 is pushed (S103). Once the shutter button 130 is pushed, the imaging apparatus 100 performs a white balance control for the still image captured.

First, the white balance detector 132 adds up signal levels (intensities of color signal) of color signals Rsignal, Gsignal, and Bsignal of the three primary colors in respective division areas of the imaging area of the CCD 102 (S104). Then the white balance controller 134 calculates gains of the color signals to control a white balance (S105).

The imaging apparatus 100 also determines whether the illuminating devices 124 and 126 are needed to emit light according to an exposure control of the CPU 120 based on the amount of light received by the CCD 102 or a users' manipulation command (S106). If light is not emitted, the shutter is operated and the image of a subject imaged by the CCD 102 is acquired, thereby completely performing photographing.

But if in S106 the imaging apparatus 100 determines that illuminating devices 124 and 126 emit light, the illumination controller 122 calculates an illumination color temperature based on the gains acquired by the white balance controller 134 (S107). The illumination color temperature is calculated in such a way that the illumination color temperature approximates the color temperature of the light of the subject received by the CCD 102.

Then the illumination controller 122 controls the illuminating devices 124 and 126 to emit light of the calculated illumination color temperature (S108). Among the illuminating devices 124 and 126, an illuminating device having a color temperature that is similar to the color temperature of the light of the subject received by the CCD 102 emits light to the subject. As a result, when the illuminating devices 124 and 126 emit light during photography, the color temperature of an indoor wall may be equal to the color temperature of a person or thing right in front of the illuminating devices 124 and 126 emitting light. Therefore, a mixed light (MIX light) is not formed and a good white balance can be acquired.

Hereinafter, the gain calculation process in the auto white balance mode will be described in detail. In the auto white balance mode, the white balance controller 134 calculates gains of color signals Rg, Gg, and Bg to control a white balance.

The gains of color signals Rg, Gg, and Bg may be represented by the following equation.

$$Gg = 1 , \\ Rg = \frac{Gd}{Rd} \times Gg , \\ Bg = \frac{Gd}{Rd} \times Gg \qquad Equation 2$$

where Rd, Gd, and Bd respectively denote entire screen average values of color signals of the three primary colors Rsignal, Gsignal, and Bsignal of an image signal formed by converting light received by the CCD 102.

Then, entire screen average values of respective color signals Rd, Gd, and Bd are calculated. FIG. 9 is a flowchart illustrating how the entire screen average value Rd of an Rsignal is calculated. The same evaluation, however, is also applied to a Bsignal and a Gsignal.

First, n is set as 0 and Rdₛᵤₘ is set as 0 (S121), and then it is determined whether the sum R[n] of signal levels Rsignal of each pixel in an division areas areaₙ acquired by the white balance detector 132 is greater than an evaluation allowance lower limit Btm and smaller than an evaluation allowance upper limit Top (S122).

If the sum R[n] is within that range, the calculated R[n] is added to Rdₛᵤₘ (S123). However, a sum R[0] is outside that range, the calculated R[0] is not added to Rdₛᵤₘ because the error is increased, and then the subsequent process is performed. Then, an operation n=n+1 is performed (S124).

For example, when n=0, n=1 is acquired by n=n+1, it is also determined whether n is smaller than 64 (S125). If n is smaller than 64, Operations S122 through S124 are repeatedly performed until n is 64. When n is 64, an average value of signal levels Rsignal in one division area Rdₐᵥ (S126) is calculated.

Rdₐᵥ may be calculated by dividing Rdₛᵤₘ by the number of division areas n, for example, 64. If a different number of divisions is used in another embodiment, the following equation may be used:

Rdₐᵥ=Rdₛᵤₘ/n

Next, an average value of signal levels Rsignal in one pixel Rd is calculated by using the average value of signal levels Rsignal in one division area Rdₐᵥ (S127). As illustrated in the following equation, Rd may be calculated by dividing Rdₐᵥ by the number of pixels included in one division area P.

Rd=Rdₐᵥ/P

In the auto white balance mode, gains of respective color signals Gg, Rg, Bg can be calculated by using the calculated entire screen average values of respective color signals Rd, Gd, and Bd through Equation 2.

The gain calculation process in the manual white balance mode will now be described in detail. In the manual white balance mode, first, a user determines a light source pattern of the illuminating devices 124 and 126 applied to a subject.

Next, the white balance controller 134 acquires gains of color signals of the three primary colors corresponding to the chosen light source pattern from the table storage unit 142.

The illumination controller 122 calculates an illumination color temperature based on the gains acquired by the white balance controller 134. The illumination color temperature of the emitted light is a color temperature based on the light source pattern chosen by the user.

Then, the illumination controller 122 controls the illuminating devices 124 and 126 so that an illuminating device having the calculated color temperature emits light. The light source pattern for the white balance control may be, for example, a bulb (tungsten) mode or a fluorescent lamp mode, and the user chooses the light source pattern according to an indoor light source of the subject.

The illuminating devices 124 and 126 emits light having a color temperature calculated based on the gains of color signals corresponding to the chosen light source pattern to a subject. As a result, when the illuminating devices 124 and 126 emit light during photographing, the color temperature of an indoor light source of the subject determined by a user may be equal to the color temperature of a person or thing right in front of the illuminating devices 124 and 126 emitting light. Thus, a mixed light (MIX light) is not formed and thus, a good white balance can be obtained. In addition, when the color of the subject cannot be separated from the color of the light source, for example, when the color of the subject itself is similar to the color of the indoor light source, misleading determination can be prevented by choosing the manual white balance mode.

In addition, even when the manual white balance mode is chosen, a good white balance can be obtained without controlling the illuminating devices 124 and 126 not to emit light. In addition, since a shutter opening for a long period of time or a gain up, which are needed to compensate the lack of light, are not needed, an image may not be deteriorated.

According to the current embodiment, the illumination controller 122 calculates an illumination color temperature by using gains Rg, Gg, and Bg immediately before the shutter button 130 is pushed and calculates a color temperature control value based on graphs illustrated in FIGS. 3 and 5, and allows the illuminating devices 124 and 126 to emit light. The optical information of the subject illuminated by the illuminating devices 124 and 126 is acquired by the CCD 102. The optical information acquired by the CCD 102 is converted into electrical signals and then, the electrical signals are subjected to, for example, YC conversion or JPEG compression, and thus, image data is recorded in the recording medium 152.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A color temperature compensating imaging apparatus, comprising:
a gain acquisition unit that acquires gains of color signals of an image of a subject;
an illumination unit comprising a light source of which illumination color temperature is controlled when the subject is illuminated; and
an illumination control unit that calculates the illumination color temperature based on the acquired gains, and controls the illumination unit controlling the illumination color temperature based on the calculated illumination color temperature.

2. The color temperature compensating imaging apparatus of claim 1, further comprising:
a light receiving unit that receives light from the subject and separates the light into color signals of the three primary colors; and
a memory that stores gains of the color signals corresponding to each of a plurality of patterns,
wherein the gain acquisition unit calculates a ratio of the color signals, and comprises:
a first mode acquiring the gains based on the ratio; and
a second mode acquiring the gains according to any one pattern from the plurality of patterns, and
the illumination control unit calculates the illumination color temperature based on the gains acquired in any one mode of the first mode and the second mode.

3. The color temperature compensating imaging apparatus of claim 1, further comprising:
a light receiving unit that receives light from the subject and separates the light into color signals of the three primary colors,
wherein the gain acquisition unit calculates the ratio of the color signals of the three primary colors and acquires the gains based on the ratio.

4. The color temperature compensating imaging apparatus of claim 1, further comprising:
a memory storing gains of the at least two color signals corresponding to each of the plurality of patterns,
wherein the gain acquisition unit acquires the gains according to any one pattern from the plurality of patterns.

5. The color temperature compensating imaging apparatus of claim 1, further comprising:
a white balance control unit that controls the color signal of the image of the subject based on the acquired gains and controls the white balance of the image of the subject.

6. A color temperature compensating imaging method comprising:
acquiring gains of color signals to control a white balance of an image of a subject;
calculating an illumination color temperature of an illumination unit comprising a light source of which illumination color temperature is controlled when the subject is illuminated, based on the acquired gains; and
controlling a control of the illumination color temperature in the illumination unit, based on the calculated illumination color temperature.

7. The color temperature compensating imaging method of claim 6, further comprising:
receiving light from the subject and separating the light into color signals of the three primary colors; and
memorizing gains of the color signals corresponding to each of a plurality of patterns in advance;
wherein, for the calculating of the illumination color temperature, the illumination color temperature is determined based on the gains acquired in a first mode or a second mode,
wherein in the first mode, a ratio of the color signals of the three primary colors is calculated and the gains are acquired based on the ratio,
in the second mode, the gains are acquired according to any one pattern from the plurality of patterns.

8. A color temperature compensating imaging apparatus, comprising:
a means for acquiring gains of color signals of an image of a subject;
a color temperature adjustable means for illuminating the subject; and
a means for calculating a white balance from the color signals of the image of a subject and adjusting the color temperature adjustable means based on a calculated illumination color temperature.

9. The color temperature compensating imaging apparatus of claim 8, further comprising:
a means for receiving light from the subject and separating the light into color signals of the three primary colors; and
a means for storing gains of the color signals corresponding to each of a plurality of patterns,
wherein the means for acquiring gains calculates a ratio of the color signals of the three primary colors.

10. The color temperature compensating imaging apparatus of claim 8, further comprising:
a means for receiving light from the subject and separating the light into color signals of the three primary colors,
wherein the means for acquiring gains calculates a ratio of the color signals of the three primary colors and acquires the gains based on the ratio.

11. The color temperature compensating imaging apparatus of claim 8, further comprising:
a means for white balancing that controls the color signals of the image of the subject based on the acquired gains and controls the white balance of the image of the subject.
